(19) United States
(12) Patent Application Publication
(10) Pub. No.: US 2005/0227689 A1
(43) Pub. Date: Oct. 13, 2005

(54) Method and apparatus for automatic calibration of positioning system base stations

(76) Inventor: David T. Jewett, Loon Lake, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/823,251

(22) Filed: Apr. 13, 2004

(51) Int. Cl. H04Q 7/20

(52) U.S. Cl. 455/433

(57) ABSTRACT

The present invention is a method and apparatus for automatic calibration of wireless positioning system base stations. An automated system and method for calibrating a location system comprises obtaining at least one position assertion with a corresponding base station-centric position assertion on at least on mobile communication device. A latency calibration record is maintained which includes a current base station latency estimate for a base station controller. The measured position assertion is analyzed in relation to base station-centric position assertion and the latency calibration record, to develop a new base station latency estimate. The latency calibration record is refined using the new base station latency estimate and the steps are repeated to further refine the latency calibration record.

### BACKGROUND OF THE INVENTION

1. Field of the Invention

The present invention relates generally to position determining systems in communication networks. More particularly, the present invention relates to automating calibration processes for wireless base stations and the position determining systems within the wireless communication networks.

2. Description of Related Art

Position determining systems have become increasingly important in the wireless communication technology, particularly with requirements to provide an enhanced 911 service. Many techniques exist that attempt to determine the location of a handset within a wireless network. These techniques generally center on network-based solutions, handset-based solutions and hybrids of these two solutions.

Handset solutions are generally based on Global Positioning Systems (GPS) technology. GPS is a satellite based system that can provide accurate latitude, longitude and altitude position information for anywhere on or near the earth. A terrestrial-based GPS receiver can determine its location by accurately measuring the distance between the receiver and at least four satellites in a network of GPS satellites orbiting the earth. Recently, GPS receiver technology has become cost effective for placement within cellular telephone handset units (also referred to as mobile communication devices). However, obtaining an accurate GPS location fix can take time; depending on the technology, sometimes it can take up to one or two minutes. Additionally, in many locations, such as indoors, or urban areas with tall buildings, the GPS receiver may not be able to receive adequate signal levels from enough satellites to acquire an accurate position fix.

Many solutions are based in part on methods and technology that measure the distance between one or more base stations and a handset. These solutions include both handset-based and network-based solutions, and derive location information by measuring the transit time of signals between a handset and wireless network antennas (also referred to as base stations). Solutions such as Enhanced Observed Time Difference (EOTD) and Observed Time Difference of Arrival (OTDOA), determine the signal arrival time differences between the handset and at least three base stations to create a two-dimensional (i.e., latitude and longitude, altitude is not determined) position determination. Solutions such as Advanced Forward Link Trilateration (AFLT) derive location information by measuring the distance between the handset and each base station and calculating the location by solving for multiple intersecting arcs (each arc is defined by the distance between a handset and one base station). By measuring the signal transit time from the handset to a base station (uplink methods), or from a base station to a handset (downlink methods) a distance between the handset and base station can be calculated based on the speed of signal travel (i.e., near the speed of light). Clearly, the signal travel time is very short and should be derived as accurately as possible. Any intrinsic delays in the base station that remain unaccounted for or uncalibrated will cause errors in the position estimate. For purposes of this discussion, location estimates that are generated by handset/base station range measurements, such as those already discussed, will henceforth be referred to as “base station-centric” location estimates.

Hybrid, or assisted GPS (AGPS), solutions typically combine portions of a GPS solution and a base station-centric solution. When GPS locations are available from a handset, they can be used. When GPS solutions are unavailable, or prior to an accurate GPS solution, a base station-centric solution can be used. Additionally, for some base station-centric solutions, the GPS measurements can be used to augment and enhance the accuracy of the base station-centric position estimates. Refining the accuracy of the base station-centric location prediction is an iterative process. This iterative process can assist in compensating for inaccuracies due to reflection and multi-path signal degradations as well as measuring the timing latencies inherent in base station processing due to base station electronics and computation delays. Calibrating base station latencies has typically been accomplished in two manners.

The first process is for a technician to actually travel to the physical base station site and use electronic measuring equipment to measure the latency that is inherent in the base station. The technician then uses the latency measurements to create a calibration value that is maintained in some form of base station database—which is typically stored at a Position Determining Entity (PDE) or other location determination module. The PDE or other location determination module can then use this calibration value in removing the inherent latency from future timing measurements and location fixes.

The second process involves multiple measurements of actual time differences from multiple handset calls. in this process, a field tester will take a handset to a location served by the base station to be calibrated. The field tester then makes repeated calls that generate GPS assisted location fixes. The GPS location (actual) and base station-centric location (estimated) are stored for each of these calls at the PDE or other location determination module. When a sufficiently large sample of calls have been collected, a PDE operator then performs a procedure that correlates the GPS location and the base station-centric location estimates to calculate differences between each of the multiple calls. These differences approximate the inherent latency within the base station. This approximation is then used to derive the calibration value for removing the inherent latency for future timing measurements. Generating more calls through this process will refine the calibration. However, both of these solutions are manually intensive. An automated process is needed to reduce the human intervention and assistance, making the calibration process more cost effective.

### BRIEF SUMMARY OF THE INVENTION

A method and apparatus for automatic calibration of wireless positioning system base stations is provided. In one embodiment of the present invention, an automated method for calibrating a location system comprises obtaining at least one position assertion with a corresponding base station-centric position assertion on at least one mobile communication device. A latency calibration record is maintained which includes a current base station latency estimate for a base station controller. The measured position assertion is analyzed in relation to the base station-centric position assertion and the latency calibration record, to develop a new base station latency estimate. The latency calibration record is refined using the new base station latency estimate and the steps are repeated to further refine the latency calibration record.

### BRIEF DESCRIPTION OF THE DRAWINGS

In the drawings, which illustrate what is currently considered to be the best mode for carrying out the invention:

FIG. 1 is a system diagram showing the communication elements for finding the location of a mobile communication device, in accordance with an embodiment of the present invention;

FIG. 2 is a system diagram showing the elements involved in maintaining, calibrating, and updating the data necessary for location determination, in accordance with an embodiment of the present invention;

FIG. 3 shows a base station almanac database and a latency calibration record as part of the database;

FIG. 4 shows the processes and databases involved in maintaining, calibrating, and updating the data necessary for location determination, in accordance with an embodiment of the present invention;

FIG. 5 is a flow diagram of a calibration process; and

FIG. 6 is a flow diagram of the automation and synchronization procedure, in accordance with an embodiment of the present invention.

### DETAILED DESCRIPTION OF THE INVENTION

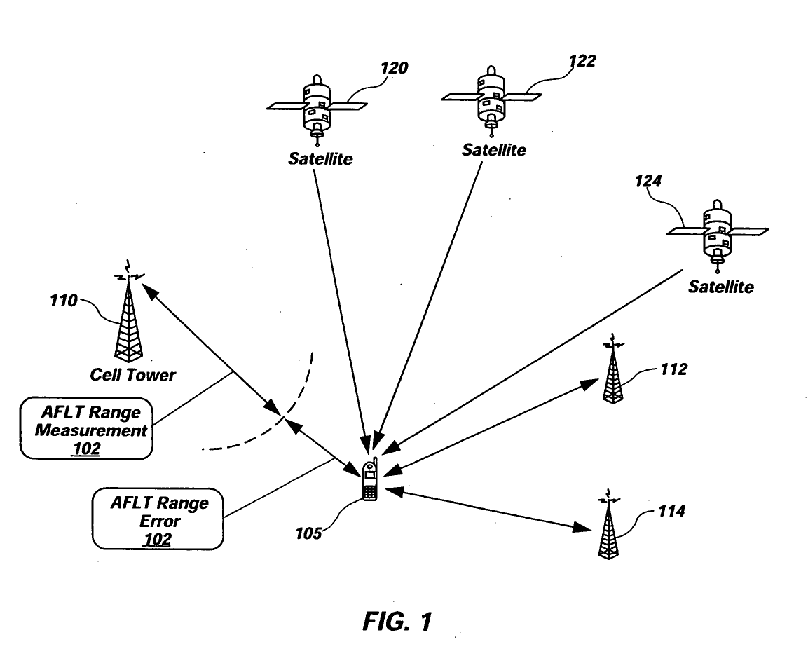

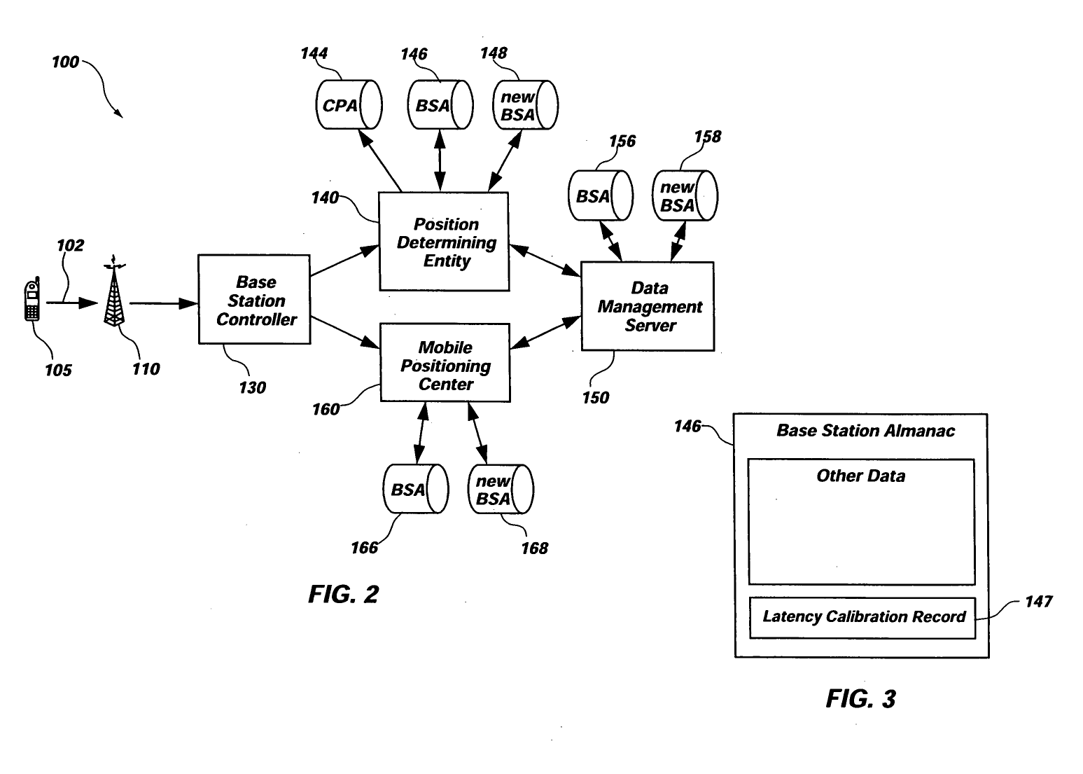

FIG. 1 illustrates an AGPS system for finding the geographical location of a mobile communication device 105 (also referred to as a mobile handset). The mobile communication device 105, if equipped with GPS location equipment, attempts to acquire a location fix by sensing the signal from at least three GPS satellites (120, 122, and 124) orbiting the Earth. At the same time, a location estimate is attempted using a base station-centric location procedure such as, for example, AFLT, EOTD, or OTDOA. This location estimate is derived by measuring signal timing differences between at least three different cell towers, also referred to as base transceiver systems (110, 112, and 114), or by obtaining distance (range) measurements between the handset and each participating cell tower. The location estimate range measurement 102 (FIG. 1) is transmitted to the cell tower currently managing the communication of mobile communication device 105. Due to the latency inherent in the base station controllers 130 (FIG. 2) the location estimate 102 may contain one or more range errors 104 that need to be corrected.

FIG. 2 illustrates a position location system 100 with calibration system components that are used to determine, correct, and refine this range error 104. The system uses the mobile communication device 105, communicating with a base transceiver system 110. The mobile communication device 105 communicates with the base transceiver system 110, which in turn communicates with a base station controller 130. This communication may also contain a location estimate or range measurement 102 indicating a current position based on a GPS measurement combined with a base station-centric range measurement, such as an AFLT, EOTD, and/or OTDOA measurement. The base station controller 130 then transmits the location assertion 102 to a position determining entity (PDE) 140, or other position determination engine (such as a GMLC under GSM). The PDE 140 stores this location estimate 102 in a current position assertion database (CPA) 144. The position location system 100 may process each location fix from each communication device 105 on an individual basis, or it may process and collect multiple location assertions 102 from multiple communication devices 105 and store each of the assertions 102 in the current position assertion database 144.

The PDE 140 is responsible for performing the calculations that determine the current location of the mobile communication device 105 based on the location estimate 102 and base station data stored in a base station almanac (BSA) database 146. As shown in FIG. 3, the BSA database 146 contains, among other things, data that can be used to provide a current estimate of the base station controller's 130 latency. This current estimate is referred to as a latency calibration record 147. The PDE 140 uses this latency calibration record 147 generated from the BSA database 146 data in combination with other base station data and the location estimate 102 to determine the current location of the mobile communication device 105.

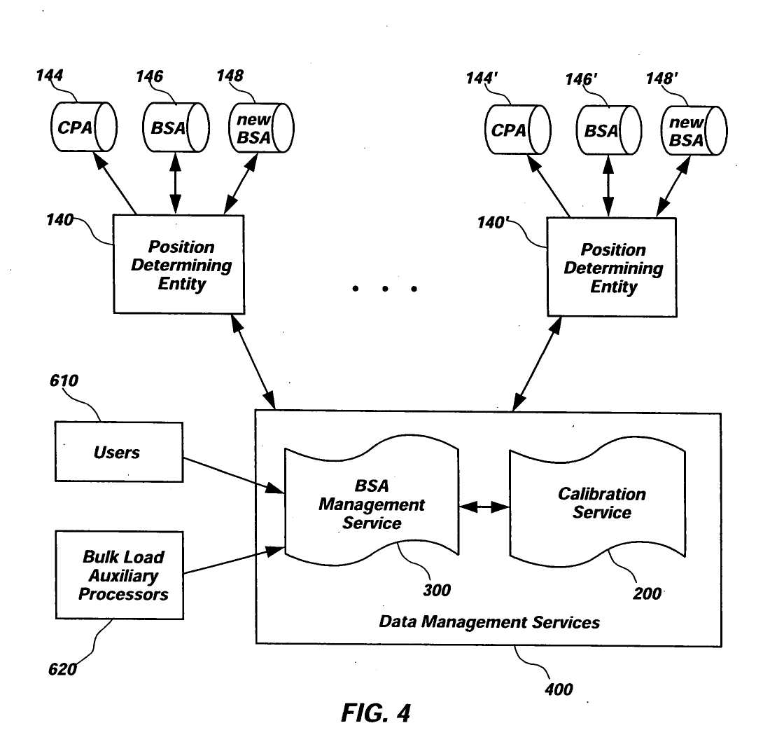

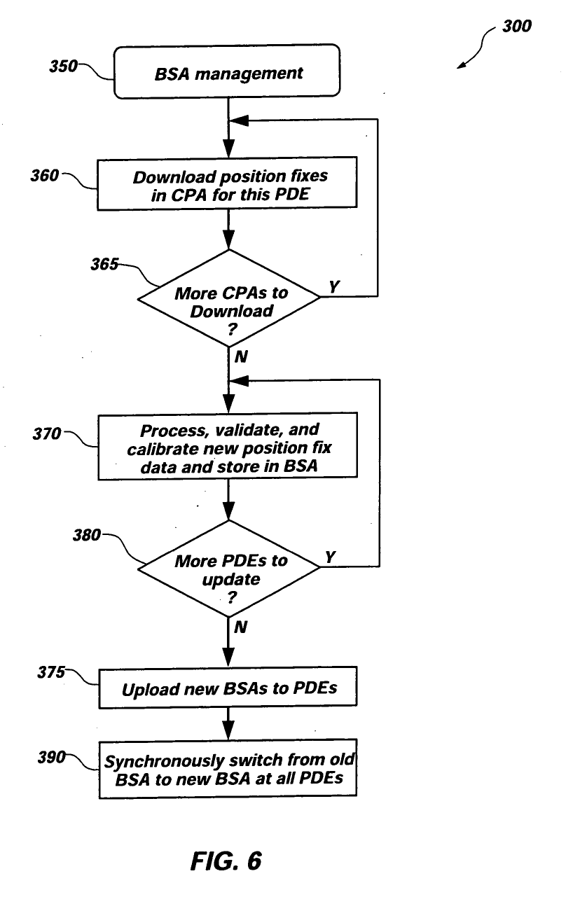

FIG. 4 illustrates the Base Station Almanac management service 300 and its relationship to other location system 100 components. The BSA management service 300 ensures that the current position assertion database 144 is associated with the correct version of the base station almanac database 146—that is, the version of the BSA database 146 that was used in creating the CPA 144—for calibration purposes. To this end, the BSA management service 300 provides a centralized service to receive and manage updates to the BSA database 146 and ensures that updates become effectively synchronized at the completion of a calibration cycle. The BSA management service 300 may receive updates to the BSA database 146 from users 610, Bulk Load Auxiliary Processors 620, and the calibration service 200. When the calibration service 200 signals calibration completion, the BSA management service 300 merges all of the changes from the calibration service 200, the users 610, and the Bulk Load Auxiliary Processors 620 into the new BSA database 148. The BSA management service 300 then distributes the new BSA database 158 to the PDEs (140 and 140′) and Mobile Positioning Centers (MPCs) 160 (not shown in FIG. 4). The BSA management service 300 performs distribution of the new BSA database 158 according to the processing steps described below and shown in FIG. 6.

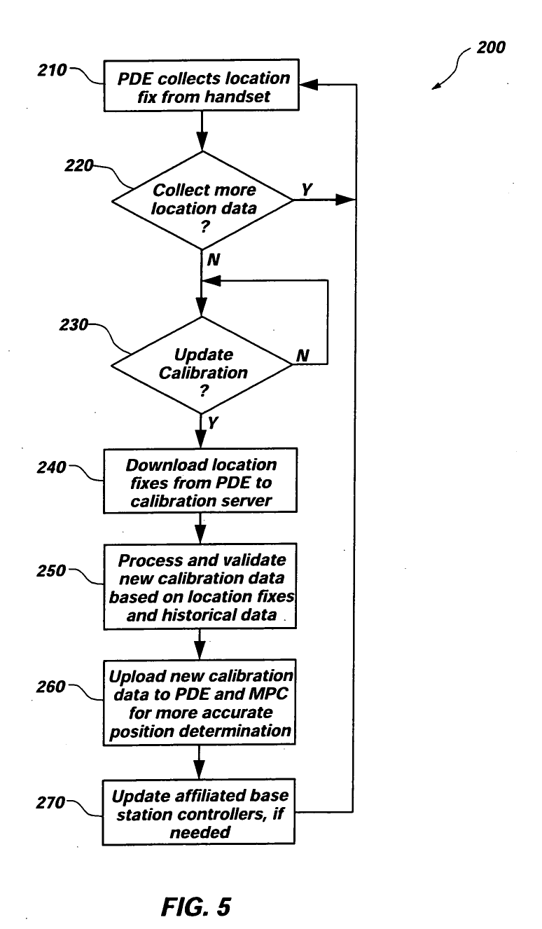

FIG. 4 also illustrates the calibration service 200 and its relationship to BSA management service 300, other location system 100 components, and the database components necessary to perform calibration. The calibration service 200 receives one or more CPAs (144 and. 144′) and the corresponding BSA databases (146 and 146′) that were used to generate the CPA data from one or more PDEs (140 and 140′). The calibration service 200 outputs new latency calibration records 147 that are submitted to the BSA management service 300 for update into a new BSA database 148, 148′. (FIG. 4). The calibration service 200 performs. the calibration according to the processing steps described below and shown in FIG. 5.

For purposes of this discussion, the Base Station Almanac Management Service 300 and the calibration service 200 will henceforth be referred to as the data management services 400, except where a distinct reference is necessary to enhance the clarity of this description. Additionally, while the calibration service 200 and BSA management service 300 are shown together in FIG. 4, and may typically be located on the data management server 150 shown in FIG. 2, it will be understood by a person skilled in the art that the services may exist in different locations and/or on different computing systems in communication with each other.

After a predetermined time period, a predetermined number of location assertions 102, when requested by the BSA management service 300, or receipt of a user command, the calibration service 200 may execute a calibration process, which is used to refine and enhance the current base station latency estimate. This calibration process is described more fully below, however, FIG. 2 and FIG. 4 depict the database files used in implementing the calibration and update process. After the calibration service 200 is performed, a new BSA database 148, along with the BSA database 146 and CPA 144, may be uploaded by the BSA management service 300 to the position determining entity 140 so that a transition from the BSA database 146 to the new BSA database 148 can be performed. The BSA management service 300 also maintains a duplicate copy of both the BSA database 156 and a duplicate of the new BSA database 158. The new BSA database 158 contains a new latency calibration record 147, which may be used to derive more accurate location measurements of future location requests.

An additional element in the system is a MPC 160. The MPC 160 may not directly participate in the calibration and update process, it may, however, use the BSA database 166. The MPC 160, therefore, may participate in the processes described below in updating and synchronizing the BSA database updates. As a result, the MPC maintains its own copies of the BSA database 166 and new BSA database 168 sent to it from the data management server 150.

The base station calibration process, in accordance with one embodiment of the present invention, is shown in FIG. 5. The process typically begins at the PDE 140 in a continuous loop. The PDE 140 continuously collects 210 location assertions 102 that are transmitted from the mobile communication devices 105, through the base transceiver system 110, through the base station controller 130, and to the PDE 140. The PDE 140 completes collection 220 and stores these location assertions 102 received from the mobile communication device 105 in the current position assertion database 144. Generally, when the current position assertion database 144 becomes full, the PDE 140 closes out the current file and begins a new file.

Concurrent with the PDE 140 collecting location assertions 102, the PDE 140 may monitor for a calibration update 230 event, or it may explicitly invoke a calibration event. The calibration update process may be triggered by the PDE 140 sending a request to a calibration service 200 or by the calibration service 200 initiating the update. To begin the update process, the calibration service 200 typically downloads 240 the CPA database 144 from the PDE 140. The calibration service 200 may also retrieve a copy of the current BSA database 156. The current BSA database 156 is the BSA database that was used during generation and creation of the CPA database 144—this is desirable because the BSA database 156 contains numerous base station parameters—such as the latitude and longitude of each base station—that should be the same as when the CPA database 144 was generated.

Calibration processing may be performed according to a variety of parameters, such as: if a calibration is desired after each new location assertion 102, after a predetermined number of location assertions 102 have been collected, after a predetermined time period has passed since the last update, or at a time requested by the calibration service 200.

This calibration process 250 may be performed in many ways. In one exemplary embodiment, the calibration calculations are performed by a commercially available software package entitled SnapCell™ available from SnapTrack, Inc. of Campbell, Calif. The calibration process steps through each entry in the CPA 144 and submits the GPS and network generated location data for that CPA entry along with previously accumulated range measurements stored within the current BSA database 146 to develop more precise forward link calibration and sector/center position values, which are used in determining the latency calibration record 147. As an example, the presently preferred embodiment uses the following formula to calculate the forward link calibration (FLC)—which is a measure of base station latency.
FLCnew=FLCold+(Residual/30.52)
FLCnew=the new forward link calibration value, in Chip_x_{—}8 units.
FLCold=FLC value from the BSA that was used during collection of the location assertions.
Residual=the residual for a specific sector pseudo-range measurement, in meters 30.52=the number of meters per Chip_x_{—}8 units.

Alternative calibration algorithms are possible to account for parameters such as alternative location technology, different levels of accuracy, and alternative elevation determinations.

Processing of each entry in the CPA 144 develops a more refined estimate of the latency calibration record 147. Once all CPA 144 entries are processed.250, the final latency calibration record 147 is available based on the data from the current CPA database 144.

The next step in the calibration process 250 is to upload 260 (FIG. 5) the new BSA database 158 containing the latency calibration record 147 to the PDE 140. The PDE 140 stores this uploaded data as the new BSA database 148. At a predetermined time, outlined below in the section on BSA management service 300, a switch is made to make the new BSA database 148, the current BSA database 146. The current BSA database 146 being replaced may be discarded or saved as an old BSA database for possible historical processing.

Generally, a PDE 140 will serve multiple affiliated base station controllers 130. In this case, the new BSA database 148 would contain data for all affiliated base station controllers 130. As a result, the process would typically update 270 the new BSA database 148 on each of the base station controllers 130 associated with that particular new BSA database 148.

The process of automating BSA database 146 management across an entire network or a subset of the network is performed by the BSA management service 300, as shown in FIG. 6. The BSA database 146 processing may be performed either by operator command, or by some form of automatic operation, such as a scheduled process. In either case, the processing steps achieve the same objectives: to update any data relevant to calculating a new latency calibration record 147, to update other unrelated BSA database 146 data, to recalibrate the entire network, and to synchronize the updated data across all participating PDEs 140 and MPCs 160.

The bulk BSA database 146 processing or management 350 (FIG. 6), which may be performed on the data management server 150, typically begins by performing loop 365 which downloads 360 the CPA 144 from each PDE 140. After the CPA 144 file(s) are downloaded for each PDE 140, the BSA management service 300 performs loop 380 to perform calibration on all of the base stations defined in each PDE's 140 BSA database 146, as described in the calibration section. The calibration data is submitted to the BSA management service 300 for update into the new BSA database 148, where validation is performed. The process then loops 380 back to processing, calibrating, and validating 370 a new BSA database 158 until all PDEs 140 within the update task list have been processed. After calibration, validation, and updates of all new BSA databases 158 are processed 370, the new BSA databases 158 may be uploaded 375 from the data management server 150 to the PDE 140 as new BSA databases 148 within the PDE 140.

Finally, when all PDEs 140 have been processed and new BSA database 148 databases are loaded into the PDEs 140, the data management server 1 50 may cause a synchronous switch 390 from the BSA database 146 to the new BSA database 148 so that all PDE's 140 in the network are working with data generated from the same bulk update procedure. As part of the switch from BSA database 146 to new BSA database 148, current CPA 144 files are closed and new CPA 144 files are opened—this facilitates the PDE's 140 ability to record new current position assertions based on the new BSA database 148.

Clearly, the steps defined for the calibration service 200 and BSA management service 300 in the presently preferred embodiment may be performed in a different order and still fall within the scope of the present invention as long as the synchronous switching is performed in a manner such that all PDEs 140 have new. data at the same time. For example, in the BSA management service 300, rather than waiting to upload the new BSA databases 158 until after all new BSA databases 158 have been processed, the BSA management service 300 may upload the new BSA databases 158 as part of the loop 380. In other words, upload each new BSA database 158 after processing of that BSA database 158 is complete.

Specific embodiments have been shown by way of example in the drawings and have been described in detail herein, however the invention may be susceptible to various modifications and alternative forms. It should be understood that the invention is not intended to be limited to the particular forms disclosed. Rather, the invention includes all modification, equivalents, and alternatives falling within the spirit and scope of the invention as defined by the following appended claims.

1. A method for calibrating a location system, comprising:
receiving at least one location assertion from at least one mobile communication device; and
updating a latency calibration record comprising a current base station latency estimate for a base station controller, wherein the updating comprises:
developing a new base station latency estimate by analyzing the at least one location assertion in relation to the latency calibration record; and
refining the latency calibration record using the new base station latency estimate.

2. The method of claim 1, further comprising periodically repeating the receiving and updating.

3. The method of claim 1, wherein the at least one location assertion comprises:
a global positioning system location estimate; and
a range estimate.

4. The method of claim 3, wherein the range estimate is derived from a method selected from the group consisting of advanced forward link trilateration, enhanced observed time difference, and observed time difference of arrival.

5. The method of claim 1, wherein the new base station latency estimate is derived from the at least one location assertion and forward link calibration data, sector center data, and sector position data in the latency calibration record.

6. The method of claim 1, wherein the method for calibrating a location system is performed at a time selected from the group consisting of a predetermined time interval, after a predetermined number of samples, and on demand from a data management service user.

7. The method of claim 1, further comprising evaluating the new base station latency estimate for at least one additional base station controller affiliated with the latency calibration record.

8. A method for calibrating a location system, comprising:
receiving at least one location assertion from at least one mobile communication device;
developing a current position assertion database by collecting a plurality of received location assertions; and
updating a latency calibration record comprising a current base station latency estimate for a base station controller, wherein the updating comprises:
developing a new base station latency estimate by analyzing the current position assertion database in relation to the latency calibration record; and
refining the latency calibration record using the new base station latency estimate.

9. The method of claim 8, further comprising periodically repeating the developing the current position assertion database and updating the latency calibration record.

10. The method of claim 8, wherein the at least one location assertion comprises:
a global positioning system location estimate; and
a range estimate.

11. The method of claim 10, wherein the range estimate is derived from a method selected from the group consisting of advanced forward link trilateration, enhanced observed time difference, and observed time difference of arrival.

12. The method of claim 8, wherein the new base station latency estimate is derived from the current position assertion database and forward link calibration data, sector center data, and sector position data in the latency calibration record.

13. The method of claim 8, wherein the method for calibrating a location system is performed at a time selected from the group consisting of a predetermined time interval, after a predetermined number of samples, and on demand from a data management service user.

14. The method of claim 8, further comprising evaluating the new base station latency estimate for at least one additional base station controller affiliated with the latency calibration record.

15. A method for updating a network of location systems, comprising:
maintaining a base station almanac for each of a plurality of position determining entities,
wherein the base station almanac is used to process location assertions;
developing a new base station almanac for each of the plurality of position determining entities;
synchronizing updates of the new base station almanac for each of the plurality of position determining entities; and
processing additional location assertions using the new base station almanac.

16. The method of claim 15, wherein the method for updating a network of location systems is performed at a time selected from the group consisting of a predetermined time interval, after a predetermined number of samples, and on demand from a data management service user.

17. The method of claim 15, wherein the synchronizing updates is performed by a method selected from the group consisting of:
setting a predetermined time in the future when an update should occur;
defining a predetermined event in the future when the update should occur; and
simultaneously sending an update signal to the plurality of position determining entities.

18. A method for calibrating a network of location systems, comprising:
developing a current position assertion database by collecting a plurality of location assertions for each of a plurality of position determining entities;
maintaining a latency calibration record comprising a current base station latency estimate for each of the plurality of position determining entities;
developing a new base station latency estimate by analyzing the current position assertion database in relation to the latency calibration record for each of the plurality of position determining entities;
synchronizing updates of the latency calibration record for each of the plurality of position determining entities;
refining the latency calibration record using the new base station latency estimate for each of the plurality of position determining entities.

19. The method of claim 18, further comprising repeating the previous steps to further refine the latency calibration record for each of the plurality of position determining entities.

20. The method of claim 18, wherein the plurality of location assertions are received from at least one mobile communication device transmitting a location assertion.

21. The method of claim 18, wherein the plurality of location assertions comprises:
a global positioning system location estimate; and
a range estimate.

22. The method of claim 21, wherein the range estimate is derived from a method selected from the group consisting of advanced forward link trilateration, enhanced observed time difference, and observed time difference of arrival.

23. The method of claim 18, wherein the new base station latency estimate is derived from the plurality of location assertions and forward link calibration data, sector center data, and sector position data in the latency calibration record.

24. The method of claim 18, wherein the method for calibrating a network of location systems is performed at a time selected from the group consisting of a predetermined time interval, after a predetermined number of samples, and on demand from a data management service user.

25. The method of claim 18, wherein the synchronizing updates is performed by a method selected from the group consisting of:
setting a predetermined time in the future when an update should occur;
defining a predetermined event in the future when the update should occur; and
simultaneously sending an update signal to the plurality of position determining entities.

26. A location calibration system, comprising:
at least one mobile communication device;
at least one base transceiver system for receiving at least one location assertion from the at least one mobile communication device;
a base station controller for receiving the at least one location assertion from the at least one base transceiver system;
a position determining entity for collecting and storing in a current position assertion database a plurality of location assertions transmitted from the base station controller;
a latency calibration record stored in the position determining entity comprising a current base station latency estimate; and
a data management server for creating a new latency calibration record using the current base station latency estimate and the current position assertion database and distributing the new latency calibration record to the position determining entity.

27. The method of claim 26, wherein the at least one location assertion comprises:
a global positioning system location estimate; and
a range estimate.

28. The method of claim 27, wherein the range estimate is derived from a method selected from the group consisting of advanced forward link trilateration, enhanced observed time difference, and observed time difference of arrival.

29. The system of claim 26, wherein the new base station latency estimate is derived from forward link calibration data, sector center data, and sector position data in the latency calibration record and the at least one location assertion.

30. The system of claim 26, further comprising a mobile positioning center for receiving the new latency calibration record from the calibration server.
